(19) United States
(12) Patent Application Publication
(10) Pub. No.: US 2026/0074231 A1
(43) Pub. Date: Mar. 12, 2026

(54) COATED ACTIVE MATERIAL, COATED ACTIVE MATERIAL PRODUCTION METHOD, POSITIVE ELECTRODE MATERIAL AND BATTERY

(71) Applicants: Panasonic Holdings Corporation, Osaka (JP); TOYOTA JIDOSHA KABUSHIKI KAISHA, Aichi (JP)

(72) Inventors: Yusuke ITO, Nara (JP); Yusuke NISHIO, Osaka (JP)

(21) Appl. No.: 19/389,873

(22) Filed: Nov. 14, 2025

Related U.S. Application Data
(63) Continuation of application No. PCT/JP2024/015946, filed on Apr. 23, 2024.

(30) Foreign Application Priority Data
May 25, 2023 (JP) 2023-086549

(51) Int. Cl. H01M 4/62; C01G 23/00; H01M 4/36; H01M 4/58; H01M 10/0562

(52) U.S. Cl. CPC H01M 4/628; C01G 23/002; H01M 4/366; H01M 4/582; H01M 4/5825; H01M 10/0562; C01P 2004/80; C01P 2006/40; H01M 2300/0068

(57) ABSTRACT

A coated active material of the present disclosure includes: a positive electrode active material; lithium carbonate present on a surface of the positive electrode active material; and a coating layer coating at least a portion of the surface of the positive electrode active material. The coating layer includes a lithium-containing fluoride. When a mass of the lithium carbonate present on the surface of the positive electrode active material is measured by neutralization titration, a proportion R1 of the mass of the lithium carbonate in a mass of the positive electrode active material is 0.43% or more and 1.4% or less.

This application is a Continuation of PCT/JP2024/015946 filed on Apr. 23, 2024, which claims foreign priority of Japanese Patent Application No. 2023-086549 filed on May 25, 2023, the entire contents of both of which are incorporated herein by reference.

### BACKGROUND OF THE INVENTION

### 1. Field of the Invention

The present disclosure relates to a coated active material, a method for producing a coated active material, a positive electrode material, and a battery.

### 2. Description of Related Art

WO 2019/135322 A1 discloses a positive electrode material including a positive electrode active material and a halide solid electrolyte. WO 2019/135322 A1 discloses, as the halide solid electrolyte, a solid electrolyte including lithium, yttrium, and at least one selected from the group consisting of chlorine, bromine, and iodine.

### SUMMARY OF THE INVENTION

The present disclosure provides a coated active material that can reduce the internal resistance of a battery.

A coated active material according to one aspect of the present disclosure includes:
a positive electrode active material;
lithium carbonate present on a surface of the positive electrode active material; and
a coating layer coating at least a portion of the surface of the positive electrode active material, wherein
the coating layer includes a lithium-containing fluoride, and
when a mass of the lithium carbonate is measured by neutralization titration, a proportion R1 of the mass of the lithium carbonate in a mass of the positive electrode active material is 0.43% or more and 1.4% or less.

According to the present disclosure, it is possible to reduce the internal resistance of a battery.

### BRIEF DESCRIPTION OF THE DRAWINGS

FIG. 1 is a cross-sectional view schematically showing the configuration of a coated active material 100 of Embodiment 1.

FIG. 2 is a flowchart showing a method for producing the coated active material 100.

FIG. 3 is an ion chromatogram of water obtained from TG-MS measurement of LiNi_{0.8}Co_{0.15}Al_{0.05}O₂ that has not been subjected to carbonate annealing.

FIG. 4 is a cross-sectional view schematically showing the configuration of a positive electrode material 200 of Embodiment 2.

FIG. 5 is a cross-sectional view schematically showing the configuration of a battery 300 of Embodiment 3.

### DETAILED DESCRIPTION OF THE INVENTION

(Findings on which the Present Disclosure is Based)

WO 2019/135322 A1 describes a positive electrode material including a positive electrode active material and a halide solid electrolyte including lithium, yttrium, and at least one selected from the group consisting of chlorine, bromine, and iodine.

However, a battery using a positive electrode material including a halide solid electrolyte is subjected to oxidative decomposition of the halide solid electrolyte during charge. The oxidative decomposition product serves as a resistance layer to increase the internal resistance of the battery during charge. The increase in the internal resistance of the battery during charge is inferred to be due to an oxidation reaction of at least one element selected from the group consisting of chlorine, bromine, and iodine included in the halide solid electrolyte. Thus, there is a problem with the oxidation resistance of the halide solid electrolyte.

WO 2021/187391 A1 describes that a battery using a positive electrode active material coated with a material including a lithium-containing fluoride exhibits excellent oxidation resistance. Such a positive electrode active material can suppress an increase in the internal resistance of a battery during charge. Although not yet been elucidated, the details of the mechanism are inferred as follows. Since fluorine has the highest electronegativity among the halogen elements, fluorine is strongly bonded to a cation. Consequently, a lithium-containing fluoride is less prone to the progress of an oxidation reaction of fluorine, that is, a side reaction in which electrons are extracted from fluorine. Therefore, a resistance layer due to oxidative decomposition is less prone to be generated.

On the other hand, the present inventors have made a study of the resistance of a battery using a positive electrode active material coated with a material including a lithium-containing fluoride. As a result, the present inventors have found a problem of a high output resistance during discharge. Although not yet been elucidated, the details of the mechanism are inferred as follows. In coating a positive electrode active material with a material including a lithium-containing fluoride, a lithium-containing alkaline component present on the surface of the positive electrode active material and the lithium-containing fluoride react with each other, which can deteriorate a portion of the coating layer including the lithium-containing fluoride. Here, the lithium-containing alkaline component present on the surface of the positive electrode active material means a component that does not function as the positive electrode active material, that is, a component that does not directly contribute to the occlusion and release of lithium ions. The deterioration of the coating layer generates a resistance layer at the interface between the positive electrode active material and the coating layer. This resistance layer increases the internal resistance of the battery during charge and discharge. Thus, in coating the positive electrode active material with the material including the lithium-containing fluoride, there is a problem of deterioration of the lithium-containing fluoride due to the alkaline component on the surface of the positive electrode active material, and a resulting increase in battery resistance.

WO 2023/037776 A1 describes that the amount of the alkaline component on the surface of a positive electrode active material is reduced by subjecting the positive electrode active material to a cleaning process with a water-soluble organic solvent.

From these findings, the present inventors have come to conceive of the technique of the present disclosure.

Embodiments of the present disclosure will be described below with reference to the drawings.

The following descriptions are each a generic or specific example. The numerical values, composition, shape, thickness, electrical properties, structure of secondary batteries, electrode materials, etc., shown below are illustrative, and are not intended to limit the present disclosure. In addition, the components that are not recited in the independent claims representing the broadest concepts are optional components.

### EMBODIMENT 1

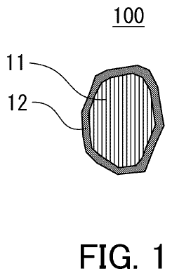

FIG. 1 is a cross-sectional view schematically showing the configuration of a coated active material of Embodiment 1. A coated active material 100 of Embodiment 1 includes a positive electrode active material 11, lithium carbonate (not shown) present on a surface of the positive electrode active material 11, and a coating layer 12. The coating layer 12 coats at least a portion of the surface of the positive electrode active material 11. The coating layer 12 is in direct contact with the positive electrode active material 11. The coating layer 12 includes a lithium-containing fluoride. When a mass of the lithium carbonate (Li₂CO₃) present on the surface of the positive electrode active material 11 is measured by neutralization titration, a proportion R1 of the mass of the lithium carbonate in a mass of the positive electrode active material 11 is 0.43% or more and 1.4% or less. In other words, when the mass of the positive electrode active material 11 is represented by M₁ and the mass of the lithium carbonate present on the surface of the positive electrode active material 11 is represented by M₂, the value determined by the expression 100×(M₂/M₁) falls within a range of 0.43 or more and 1.4 or less.

The alkaline component on the surface of the positive electrode active material 11 is, for example, a strong alkaline component such as lithium hydroxide formed by adsorption of water to a residual lithium salt on the surface of the positive electrode active material 11 and a reaction among the residual lithium salt, lithium ions eluted from the positive electrode active material 11, and water. When the strong alkaline component is generated, exchange between lithium ions and protons occurs on the surface of the positive electrode active material 11, and a Li-deficient layer (e.g., a NiO layer) is formed on the surface of the positive electrode active material 11. The presence of the Li-deficient layer is also presumed to affect the output resistance. The strong alkaline component takes in carbon dioxide in the atmosphere to generate a lithium carbonate compound such as lithium hydrogen carbonate, but as long as water and carbon dioxide are present, the generation of the strong alkaline component and the formation of the Li-deficient layer are repeated. Here, lithium carbonate has a low solubility in water. Therefore, by controlling the amount of lithium carbonate on the surface of the positive electrode active material 11 so that the proportion R1 of the mass of lithium carbonate present on the surface of the positive electrode active material 11 in the mass of the positive electrode active material 11 falls within the above range, the reaction between lithium ions and water on the surface of the positive electrode active material 11, that is, the exchange between lithium ions and protons on the surface of the positive electrode active material 11 can be suppressed, and the formation of the Li-deficient layer on the surface of the positive electrode active material 11 can be reduced. Furthermore, it is presumed that by controlling the amount of lithium carbonate on the surface of the positive electrode active material 11 within the above range, in coating the surface of the positive electrode active material 11 with the coating layer 12, deterioration of the coating layer 12 due to a reaction between the lithium-containing alkaline component present on the surface of the positive electrode active material 11 and the lithium-containing fluoride included in the coating layer 12 is suppressed. That is, it is presumed that generation of a resistance layer at the interface between the positive electrode active material 11 and the coating layer 12 due to deterioration of the coating layer 12 is suppressed. Therefore, the coated active material 100 can reduce the internal resistance of a battery.

The proportion R1 may be 0.43% or more and 1.0% or less. According to such a configuration, the internal resistance of a battery can be further reduced. The proportion R1 may be 0.45% or more and 1.0% or less, or may be 0.48% or more and 1.0% or less.

When a mass of lithium derived from a lithium-containing alkaline component present on the surface of the positive electrode active material 11 is measured by neutralization titration, a proportion R2 of the mass of lithium derived from the lithium-containing alkaline component present on the surface of the positive electrode active material 11 in the mass of the positive electrode active material 11 may be more than 0.30% and 0.40% or less. In other words, when the mass of the positive electrode active material 11 is represented by M₁ and the mass of lithium derived from the lithium-containing alkaline component present on the surface of the positive electrode active material 11 is represented by M₃, the value determined by the expression 100×(M₃/M₁) may fall within a range of more than 0.30 and 0.40 or less.

The proportion R2 may be more than 0.30% and 0.35% or less. According to such a configuration, the internal resistance of a battery can be further reduced. The proportion R2 may be 0.31% or more and 0.35% or less.

The proportion R1 and the proportion R2 are calculated by the following neutralization titration. On the surface of the positive electrode active material 11, lithium hydroxide (LiOH) and lithium carbonate (Li₂CO₃) and a trace amount of lithium hydrogen carbonate (LiHCO₃) serving as lithium carbonate compounds are present as the lithium-containing alkaline component. Here, in the neutralization titration, it is assumed that the lithium-containing alkaline component present on the surface of the positive electrode active material 11 consists only of lithium hydroxide and lithium carbonate, and the mass of lithium hydroxide and the mass of lithium carbonate are measured to calculate the proportion R1 and the proportion R2.

Neutralization titration can be performed in accordance with the Warder method. A predetermined amount (e.g., 2 g) of the powder of the positive electrode active material 11 is added to a predetermined amount (e.g., 200 mL) of ion-exchanged water, and these are stirred sufficiently (e.g., for 30 minutes) followed by standing (e.g., for 10 minutes). Next, the supernatant liquid is filtered through a syringe filter having a pore size of 0.2 μm, and the resultant filtrate is used as a test solution. A phenolphthalein solution serving as an indicator is added to the test solution, and neutralization titration is performed with use of a 0.1 mol/L aqueous HCl solution in a nitrogen atmosphere. After an end point is detected with phenolphthalein, a methyl orange solution serving as an indicator is added to the test solution, and neutralization titration is performed with use of a 0.1 mol/L aqueous HCl solution in a nitrogen atmosphere.

From the amount of HCl required to reach the end point in each of the reactions, the mass of lithium hydroxide (LiOH) included in the test solution and the mass of lithium carbonate (Li₂CO₃) included in the test solution can be calculated. From the mass of lithium hydroxide, the mass of lithium derived from lithium hydroxide can be calculated. From the mass of lithium carbonate, the mass of lithium derived from lithium carbonate can be calculated. The total of the mass of lithium derived from lithium hydroxide and the mass of lithium derived from lithium carbonate measured by the neutralization titration in this manner is taken as the mass of lithium derived from the lithium-containing alkaline component present on the surface of the positive electrode active material 11.

In the present disclosure, the “mass of lithium carbonate present on the surface of the positive electrode active material 11” substantially means the mass of lithium carbonate present in the range extracted by the above method. In the present disclosure, the “mass of lithium derived from the lithium-containing alkaline component present on the surface of the positive electrode active material 11” substantially means the mass of lithium derived from the lithium-containing alkaline component present in the range extracted by the above method.

When a mass of lithium hydroxide (LiOH) present on the surface of the positive electrode active material 11 is measured by the above neutralization titration, a proportion R3 of the mass of lithium hydroxide in the mass of the positive electrode active material 11 may be 1.0% or less. The proportion R3 may be 0.1% or more and 1.0% or less, may be 0.3% or more and 0.9% or less, may be 0.4% or more and 0.8% or less, or may be 0.56% or more and 0.73% or less. According to such a configuration, the internal resistance of a battery can be further reduced.

### (Coating Layer)

The material for the coating layer 12 is hereinafter referred to as a “coating material”. The coated active material 100 includes the positive electrode active material 11 and a coating material. The coating material includes a lithium-containing fluoride.

The lithium-containing fluoride may consist of Li, F, and at least one selected from the group consisting of Zr, Ti, and Al. Examples of such a lithium-containing fluoride include Li₂ZrF₆, Li₃ZrF₇, Li₄ZrF₈, Li₃AlF₆, and Li₂TiF₆. According to such a configuration, the ionic conductivity of the lithium-containing fluoride can be enhanced. Therefore, the internal resistance of a battery can be further reduced.

The lithium-containing fluoride may include Li, Me1, Al, and F. Here, Me1 is at least one selected from the group consisting of Ti and Zr. According to such a configuration, the ionic conductivity of the lithium-containing fluoride can be enhanced. Therefore, the internal resistance of a battery can be further reduced.

The lithium-containing fluoride may consist of Li, Me1, Al, and F. Here, Me1 is at least one selected from the group consisting of Ti and Zr. “Consisting of Li, Me1, Al, and F” means that no material other than Li, Me1, Al, or F is intentionally added, except for unavoidable impurities. According to such a configuration, the ionic conductivity of the lithium-containing fluoride can be enhanced. Therefore, the internal resistance of a battery can be further reduced.

The lithium-containing fluoride may be represented by the following composition formula (1).

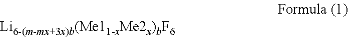

In the composition formula (1), Me1 is at least one selected from the group consisting of Ti and Zr, Me2 is at least one selected from the group consisting of Al and Y, m is a valence of Me1, and 0<x<1 and 0<b≤3 are satisfied.

In the composition formula (1), when Me1 includes a plurality of types of elements, m is a total value of products of composition ratios of the respective elements and valences of the elements. For example, when Me1 includes an element M1 and an element M2, a composition ratio of the element M1 is a1 and a valence of the element M1 is m1, and a composition ratio of the element M2 is a2 and a valence of the element M2 is m2, m is represented by m1a1+m2a2.

According to such a configuration, the ionic conductivity of the lithium-containing fluoride can be enhanced. Therefore, the internal resistance of a battery can be further reduced.

In the composition formula (1), 0<x<1 and 0<b≤1.5 may be satisfied, or 0.1≤x≤0.9 and 0.8≤b≤1.2 may be satisfied.

In the composition formula (1), 0.5≤xb<1 may be satisfied. According to such a configuration, the ionic conductivity of the lithium-containing fluoride can be enhanced. Therefore, the internal resistance of a battery can be further reduced.

In the composition formula (1), 2.5≤6−(m−mx+3x)b≤2.9, 0.1≤(1−x)b≤0.5, and 0.5≤xb≤0.9 may be satisfied. According to such a configuration, the ionic conductivity of the lithium-containing fluoride can be enhanced. Therefore, the internal resistance of a battery can be further reduced.

Me2 may include Al. Me2 may be Al.

The lithium-containing fluoride may be represented by the following composition formula (2).

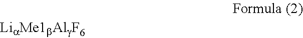

In the composition formula (2), Me1 is at least one selected from the group consisting of Ti and Zr, and α, β, and γ satisfy α+4β+3γ=6 and γ>0.

In the composition formula (2), γ may satisfy 0.5≤γ<1. According to such a configuration, the ionic conductivity of the lithium-containing fluoride can be enhanced. Therefore, the internal resistance of a battery can be further reduced.

In the composition formula (2), α, β, and γ may satisfy 2.5≤α≤2.9, 0.1≤β≤0.5, and 0.5≤γ≤0.9. According to such a configuration, the ionic conductivity of the lithium-containing fluoride can be enhanced. Therefore, the internal resistance of a battery can be further reduced.

Me1 may be Ti. Me1 may be Zr. According to such a configuration, the ionic conductivity of the lithium-containing fluoride can be enhanced. Therefore, the internal resistance of a battery can be further reduced.

The lithium-containing fluoride may be at least one selected from the group consisting of Li_{2.7}Ti_{0.3}Al_{0.7}F₆ and Li_{2.8}Zr_{0.2}Al_{0.8}F₆. According to such a configuration, the ionic conductivity of the lithium-containing fluoride can be enhanced. Therefore, the internal resistance of a battery can be further reduced.

The lithium-containing fluoride is not limited to those strictly satisfying the above composition formula, and encompasses, for example, even those including a trace amount of impurities in addition to the constituent elements represented by the composition formula (1). For example, the lithium-containing fluoride may include 10 mass % or less of impurities in addition to the constituent elements represented by the composition formula.

The lithium-containing fluoride may be represented by the following composition formula (3).

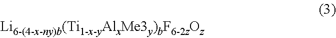

Here, Me3 is at least one selected from the group consisting of Zr, Ni, Fe, and Cr, n is a valence of Me3, and 0.1<x<0.9, 0≤y<0.1, 0≤z<0.1, and 0.8<b≤1.2 are satisfied.

In the composition formula (3), when Me3 includes a plurality of types of elements, n is a total value of products of composition ratios of the respective elements and valences of the elements. For example, when Me3 includes an element M1 and an element M2, a composition ratio of the element M1 is a1 and a valence of the element M1 is n1, and a composition ratio of the element M2 is a2 and a valence of the element M2 is n2, n is represented by n1a1+n2a2.

The coating material may include the lithium-containing fluoride as its main component. That is, the coating material may include the lithium-containing fluoride in a mass proportion of, for example, 50% or more in the entire coating layer 12.

The coating material may include the lithium-containing fluoride in a mass proportion of 70% or more in the entire coating layer 12.

The coating material may include the lithium-containing fluoride as its main component and further include unavoidable impurities, or a starting material for use in synthesizing the lithium-containing fluoride, a by-product, a decomposition product, etc.

The coating material may include the lithium-containing fluoride in a mass proportion of, for example, 100% in the entire coating layer 12, except for unavoidably incorporated impurities. As described above, the coating material may be composed only of the lithium-containing fluoride.

The coating material may be free of sulfur.

In the coated active material 100, the proportion of the volume of the coating layer 12 in the total of the volume of the positive electrode active material 11 and the volume of the coating layer 12 may be 1% or more and 10% or less. In other words, regarding a volume V1 of the positive electrode active material 11 and a volume V2 of the coating layer 12, the proportion, V2/(V1+V2), of the volume V2 of the coating layer 12 in the total (V1+V2) of the volume V1 of the positive electrode active material 11 and the volume V2 of the coating layer 12 may fall within a range of 0.01 or more and 0.1 or less. In the case where the proportion of the volume of the coating layer 12 in the total of the volume of the positive electrode active material 11 and the volume of the coating layer 12 is 1% or more, the surface of the positive electrode active material 11 can be sufficiently coated with the coating layer 12. Therefore, it is possible to effectively suppress generation of a resistance layer between the positive electrode active material 11 and the coating layer 12. In the case where the proportion of the volume of the coating layer 12 in the total of the volume of the positive electrode active material 11 and the volume of the coating layer 12 is 10% or less, an excessive coating of the surface of the positive electrode active material 11 with the coating layer 12 can be avoided. Therefore, an electron conduction path between the particles of the positive electrode active material 11 is adequately ensured. The volume V1 of the positive electrode active material 11 means the total volume of the positive electrode active material 11 in the particle group of the coated active material 100. The volume V2 of the coating layer 12 means the total volume of the coating layer 12 in the particle group of the coated active material 100. According to the above configuration, the internal resistance of a battery can be further reduced.

The proportion of the volume of the coating layer 12 in the total of the volume of the positive electrode active material 11 and the volume of the coating layer 12 can be determined by, for example, the following manner. In a cross-sectional scanning electron microscope (SEM) image of the coated active material 100 captured with an SEM, the volume proportion is calculated for each of 20 pieces randomly selected and the average value is calculated. When the volume V1 of the positive electrode active material 11, the volume V2 of the coating layer 12, and a volume V3 of the coated active material 100 are defined, the volume V2 of the coating layer 12 is determined as V3−V1. Therefore, the proportion of the volume of the coating layer 12 in the total of the volume of the positive electrode active material 11 and the volume of the coating layer 12 is determined as (V3−V1)/V3.

The volume V1 of the positive electrode active material 11 can be calculated by the following method. In a cross-sectional SEM image, the contour of the positive electrode active material 11 is extracted to calculate the area of the positive electrode active material 11. For a circle having an area equivalent to the above area, a radius (equivalent circle radius) r1 is calculated. On the assumption that the positive electrode active material 11 is a true sphere having the equivalent circle radius r1, the volume V1 of the positive electrode active material 11 can be calculated from the equivalent circle radius r1. The volume V3 of the coated active material 100 can be calculated by the following method. In a cross-sectional SEM image, the contour of the coated active material 100 is extracted to calculate the area of the coated active material 100. For a circle having an area equivalent to the above area, a radius (equivalent circle radius) r3 is calculated. On the assumption that the coated active material 100 is a true sphere having the equivalent circle radius r3, the volume V3 of the coated active material 100 can be calculated from the equivalent circle radius r3. The volume V3 of the coated active material 100 can be calculated also by the following method. The equivalent circle radius r1 of the positive electrode active material 11 calculated from the cross-sectional SEM image and the average thickness of the coating layer 12 are added together, and this is assumed as the equivalent circle radius r3 of the coated active material 100. On the assumption that the coated active material 100 is a true sphere having the equivalent circle radius r3, the volume V3 of the coated active material 100 can be calculated from the equivalent circle radius r3. The average thickness of the coating layer 12 can be determined by, for example, measuring the thickness of the coating layer 12 at 20 points randomly selected in a cross-sectional SEM image of the coated active material 100, and calculating the average value of the measured values.

The coating layer 12 may have an average thickness of 1 nm or more and 300 nm or less. In the case where the coating layer 12 has an average thickness of 1 nm or more, the surface of the positive electrode active material 11 can be sufficiently coated with the coating layer 12. Therefore, it is possible to efficiently suppress generation of a resistance layer between the positive electrode active material 11 and the coating layer 12. In the case where the coating layer 12 has an average thickness of 300 nm or less, an excessive coating of the surface of the positive electrode active material 11 with the coating layer 12 can be avoided. Therefore, an electron conduction path between the particles of the positive electrode active material 11 is adequately ensured.

According to the above configuration, the internal resistance of a battery can be further reduced.

Coating the positive electrode active material 11 with the coating layer 12 suppresses generation of an oxide film due to oxidative decomposition of a different solid electrolyte (e.g., a first solid electrolyte 21 described later) during charge of a battery. Therefore, according to the above configuration, the coated active material 100 can reduce the internal resistance of a battery.

The coated active material 100 is, for example, particulate. The particulate shape of the coated active material 100 is not particularly limited. The particulate shape of the coated active material 100 is an acicular, flaky, spherical, or ellipsoidal shape.

The types and amounts of substance of the elements included in the coated active material 100 can be determined by a known chemical analysis method.

### <Method for Producing Lithium-Containing Fluoride>

The lithium-containing fluoride included in the coating layer 12 can be produced by, for example, the following method.

Raw material powders are prepared so as to obtain the blending ratio of a target composition. For example, to produce Li_{2.7}Ti_{0.3}Al_{0.7}F₆, LiF, AlF₃, and TiF₄ are prepared in a molar ratio of 2.7:0.7:0.3. Moreover, the raw materials, the blending ratio, and the synthesis process can be adjusted to adjust the values “α”, “β”, and “γ” in the above composition formula (2).

The raw material powders are mixed together, and then mixed, pulverized, and reacted together by mechanochemical milling. Alternatively, the raw material powders may be mixed together and then sintered in a vacuum or an inert atmosphere. The sintering is performed, for example, within a temperature range of 100° C. to 800° C. for 1 hour or longer. Thus, a lithium-containing fluoride having the composition described above is obtained.

In the lithium-containing fluoride, the structure of the crystal phase (crystal structure) can be determined by adjusting the method and conditions for reaction between the raw material powders.

### (Positive Electrode Active Material)

The positive electrode active material 11 includes, for example, a material having properties of occluding and releasing metal ions such as lithium ions.

Examples of the positive electrode active material 11 include a lithium-containing transition metal oxide, a transition metal fluoride, a polyanion material, a fluorinated polyanion material, a transition metal sulfide, a transition metal oxysulfide, and a transition metal oxynitride. Examples of the polyanion material and the fluorinated polyanion material include LiFePO₄, LiCoPO₄, Li₂CoPO₄F, Li₂MnSiO₄, and Li₂FeSiO₄. Examples of the lithium-containing transition metal oxide include Li(Ni,Co,Al)O₂, Li(Ni,Co,Mn)O₂, and LiCoO₂ each having a layered rock-salt structure. For example, in the case where the lithium-containing transition metal oxide is used as the positive electrode active material 11, it is possible to reduce the production cost of the positive electrode and enhance the average discharge voltage.

In the present disclosure, when an element in a formula is expressed as, for example, “(Ni,Co,Al)”, this expression indicates at least one element selected from the group of elements in parentheses. That is, “(Ni,Co,Al)” is synonymous with “at least one selected from the group consisting of Ni, Co, and Al”. The same applies to other elements.

The positive electrode active material 11 is, for example, particulate.

The positive electrode active material 11 may include a lithium nickel-containing oxide.

The positive electrode active material 11 may include lithium nickel cobalt aluminum oxide.

According to the above configuration, the energy density of a battery can be increased.

The positive electrode active material 11 may be Li(Ni,Co,Al)O₂.

Li(Ni,Co,Al)O₂ encompasses those including at least one additive element in addition to Li, Ni, Co, and Al. The additive element can be at least one or two or more elements selected from the group consisting of boron (B), sodium (Na), magnesium (Mg), silicon (Si), phosphorus (P), sulfur(S), potassium (K), calcium (Ca), titanium (Ti), vanadium (V), chromium (Cr), manganese (Mn), iron (Fe), copper (Cu), zinc (Zn), gallium (Ga), germanium (Ge), zirconium (Zr), niobium (Nb), molybdenum (Mo), indium (In), tin (Sn), tungsten (W), lanthanum (La), and cerium (Ce).

### <Method for Producing Coated Active Material>

The coated active material 100 of Embodiment 1 can be produced by, for example, the following method.

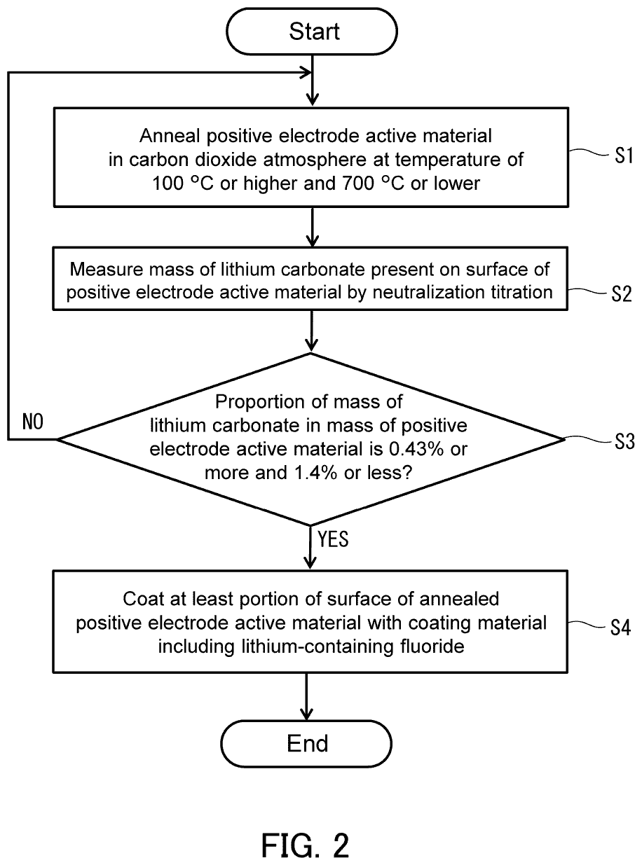

FIG. 2 is a flowchart showing a method for producing the coated active material 100. The method for producing the coated active material 100 includes: annealing the positive electrode active material 11 in a carbon dioxide atmosphere at a temperature of 100° C. or higher and 700° C. or lower (Step S1); and coating at least a portion of a surface of the positive electrode active material 11 with a coating material including a lithium-containing fluoride (Step S4).

First, the positive electrode active material 11 is annealed in a carbon dioxide atmosphere at a temperature of 100° C. or higher and 700° C. or lower (Step S1). The annealing in a carbon dioxide atmosphere may be hereinafter referred to as “carbonate annealing”.

In Step S1, to control the amount of an alkaline component on the surface of the positive electrode active material 11, the positive electrode active material 11 is annealed in a carbon dioxide atmosphere. By the carbonate annealing, the surface of the positive electrode active material 11 is coated with a component of lithium carbonate compounds. Thus, the internal resistance of a battery can be reduced. The positive electrode active material 11 may be subjected to the carbonate annealing so that when a mass of lithium carbonate present on the surface of the positive electrode active material 11 is measured by neutralization titration, a proportion of the mass of lithium carbonate present on the surface of the positive electrode active material 11 in the mass of the positive electrode active material 11 is 0.43% or more and 1.4% or less.

By annealing the positive electrode active material 11 in a carbon dioxide atmosphere, the alkaline component on the surface of the positive electrode active material 11 is controlled and stabilized as lithium carbonate. This makes it possible to stop the reaction with water, thereby stopping the reaction between lithium ions and water that continuously occurs on the surface of the positive electrode active material 11. That is, it is possible to reduce the exchange between lithium ions and protons on the surface of the positive electrode active material 11, and to reduce factors that inhibit the occlusion and release of lithium ions. In addition, by forming a film of a lithium carbonate component that does not decompose at a high potential on the surface of the positive electrode active material 11, the oxidation resistance is enhanced.

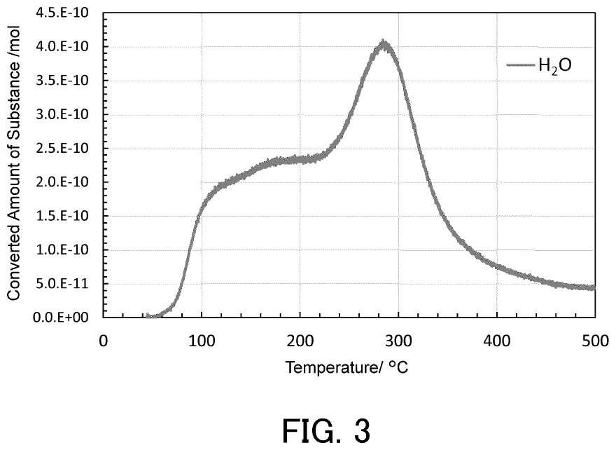

The following mechanism is assumed for the control of the lithium-containing alkaline component on the surface of the positive electrode active material 11 by the carbonate annealing. FIG. 3 is an ion chromatogram of water obtained from TG-MS measurement of LiNi_{0.8}Co_{0.15}Al_{0.05}O₂ that has not been subjected to carbonate annealing. Since a change in spectral shape is observed around 150° C., it is understood that water present on the surface of the positive electrode active material 11 starts to be removed in this temperature range. Thus, it is presumed that the alkaline component on the surface of the positive electrode active material 11 is controlled from this temperature range. A series of water release behaviors converges around 400° C. In a temperature range higher than 400° C., water release from the surface of the positive electrode active material 11 hardly occurs. From the above, the carbonate annealing at 100° C. or higher and 700° C. or lower can control the alkali on the surface of the positive electrode active material 11. The temperature of the carbonate annealing may be 100° C. or higher and 600° C. or lower, may be 150° C. or higher and 500° C. or lower, or may be 150° C. or higher and 400° C. or lower. Step S1 controls the lithium-containing alkaline component present on the surface of the positive electrode active material 11. Thus, the positive electrode active material 11 suitable for reducing the internal resistance of a battery is obtained.

A case in which the temperature of the carbonate annealing is 800° C. or higher is not suitable for reducing the internal resistance of a battery because the positive electrode active material itself deteriorates.

The time for the carbonate annealing is not particularly limited. The annealing time can be a time sufficient to control the lithium-containing alkaline component present on the surface of the positive electrode active material 11. The annealing time may be 0.5 hour or longer and 10 hours or shorter.

An apparatus for performing Step S1 is not particularly limited. For example, an electric furnace, a gas furnace, a high-frequency induction heating furnace, or the like can be used.

After the completion of Step S1, the mass of lithium carbonate present on the surface of the positive electrode active material 11 may be measured by neutralization titration (Step S2).

After the completion of Step S2, a judgment may be made as to whether the proportion of lithium carbonate present on the surface of the positive electrode active material 11 in the mass of the positive electrode active material 11 is 0.43% or more and 1.4% or less (Step S3). Steps S1 to S3 may be repeated until the proportion of the mass of lithium carbonate present on the surface of the positive electrode active material 11 in the mass of the positive electrode active material 11 becomes 0.43% or more and 1.4% or less.

After the completion of Step S3, at least a portion of the surface of the positive electrode active material 11, in which the proportion of the mass of lithium carbonate present on the surface of the positive electrode active material 11 in the mass of the positive electrode active material 11 is 0.43% or more and 1.4% or less, is coated with a coating material including a lithium-containing fluoride (Step S4). Step S4 is performed by compositing the positive electrode active material 11 and the coating material. Step S4 forms the coating layer 12 coating at least a portion of the surface of the positive electrode active material 11. Thus, the coated active material 100 is obtained.

The compositing of the positive electrode active material 11 and the coating material is performed by, for example, a dry particle compositing method. In the dry particle compositing method, the positive electrode active material 11 and the coating material are mixed together in an appropriate blending ratio and the resultant mixture is subjected to a milling process to impart a mechanical energy to the mixture. For the milling process, a mixer such as a ball mill can be used. To suppress oxidation of the material, the milling process may be performed in a dry atmosphere and an inert atmosphere.

The process by the dry particle compositing method may include stirring the mixture including the positive electrode active material 11 and the coating material while imparting a mechanical energy generated by impact, compression, and shear to the mixture. According to the dry particle compositing method, the coated active material 100 can be efficiently produced.

The apparatus that can be used in Step S4 is not particularly limited, and is any apparatus capable of imparting a mechanical energy generated by impact, compression, shear, etc. to the mixture.

According to the above production method, the proportion of the mass of lithium present on the surface of the positive electrode active material 11 in the mass of the positive electrode active material 11 can be controlled within the above range. This suppresses, in coating the surface of the positive electrode active material 11 with the coating material, deterioration of the coating layer 12 due to a reaction between the lithium-containing alkaline component present on the surface of the positive electrode active material 11 and the lithium-containing fluoride included in the coating material. That is, generation of a resistance layer at the interface between the positive electrode active material 11 and the coating layer 12 due to deterioration of the coating layer 12 is suppressed. Therefore, the coated active material 100 produced by the above production method can reduce the internal resistance of a battery.

### EMBODIMENT 2

Embodiment 2 will be described below. The description overlapping that of Embodiment 1 will be omitted as appropriate.

### [Positive Electrode Material]

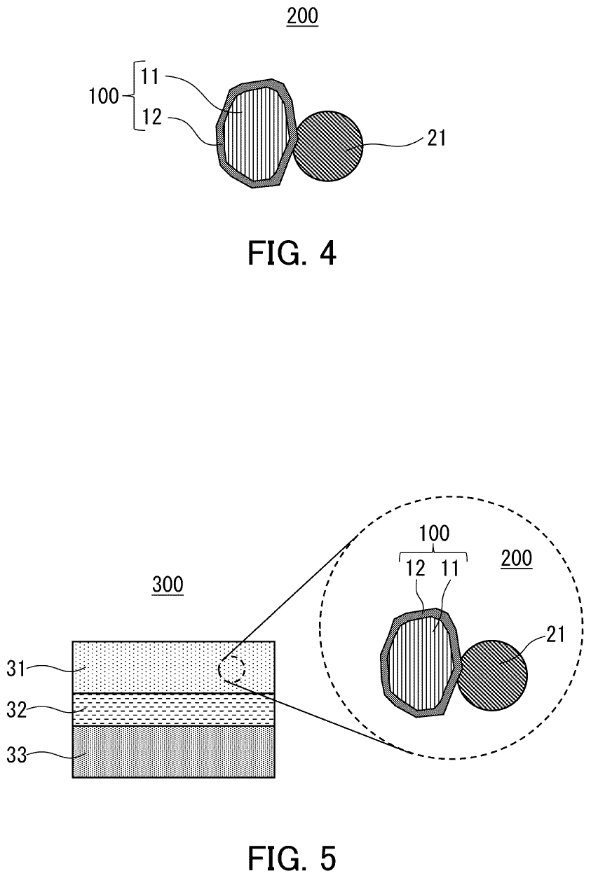

FIG. 4 is a cross-sectional view schematically showing the configuration of a positive electrode material 200 of Embodiment 2.

The positive electrode material 200 of Embodiment 2 includes the coated active material 100 of Embodiment 1 and the first solid electrolyte 21. The coated active material 100 can be produced by the production method described above. The first solid electrolyte 21 is, for example, particulate. The first solid electrolyte 21 can achieve a high ionic conductivity in the positive electrode material 200.

### (First Solid Electrolyte)

The first solid electrolyte 21 includes a solid electrolyte having a high ionic conductivity. The first solid electrolyte 21 may include a halide solid electrolyte. Halide solid electrolytes have a high ionic conductivity and excellent high-potential stability. Furthermore, halide solid electrolytes have a low electronic conductivity and high oxidation resistance, and consequently are less prone to oxidative decomposition caused by contact with the coated active material 100. Therefore, in the case where the first solid electrolyte 21 includes a halide solid electrolyte, the output characteristics of a battery can be enhanced.

The halide solid electrolyte can be, for example, Li₃(Ca,Y,Gd)X₆, Li₂MgX₄, Li₂FeX₄, Li(Al,Ga,In)X₄, Li₃(Al,Ga,In)X₆, or LiI. Here, the element X in these halide solid electrolytes is at least one selected from the group consisting of Cl, Br, and I.

The halide solid electrolyte may be free of sulfur.

The first solid electrolyte 21 may include a sulfide solid electrolyte. Sulfide solid electrolytes are excellent in ionic conductivity and flexibility. According to such a configuration, the characteristics of a battery can be enhanced.

The sulfide solid electrolyte can be, for example, Li₂S—P₂S₅, Li₂S—SiS₂, Li₂S—B₂S₃, Li₂S—GeS₂, Li_{3.25}Ge_{0.25}P_{0.75}S₄, or Li₁₀GeP₂S₁₂. To these, LiX, Li₂O, MO_{q}, LiₚMO_{q}, or the like may be added. Here, the element X in “LiX” is at least one element selected from the group consisting of F, Cl, Br, and I. The element M in “MO_{q}” and “LiₚMO_{q}” is at least one element selected from the group consisting of P, Si, Ge, B, Al, Ga, In, Fe, and Zn. The symbols p and q in “MO_{q}” and “LiₚMO_{q}” are each an independent natural number.

The first solid electrolyte 21 may be the sulfide solid electrolyte. That is, the first solid electrolyte 21 may consist of the sulfide solid electrolyte. “Consisting of a sulfide solid electrolyte” means that no material other than the sulfide solid electrolyte is intentionally added, except for unavoidable impurities. For example, the sulfide solid electrolyte may include lithium sulfide and phosphorus sulfide. For example, the sulfide solid electrolyte may be Li₂S—P₂S₅.

The first solid electrolyte 21 has a shape that is not particularly limited, and may be, for example, spherical, ellipsoidal, flaky, or fibrous. For example, the first solid electrolyte 21 may be particulate.

In the case where the first solid electrolyte 21 is particulate (e.g., spherical), the first solid electrolyte 21 may have a median diameter of 100 μm or less. In the case where the median diameter is 100 μm or less, the coated active material 100 and the first solid electrolyte 21 can form a favorable dispersion state in the positive electrode material 200. Therefore, the charge and discharge characteristics of a battery are enhanced. The first solid electrolyte 21 may have a median diameter of 10 μm or less.

In the present specification, the “median diameter” means a particle diameter at a cumulative volume equal to 50% in a volumetric particle size distribution. The volumetric particle size distribution is measured with, for example, a laser diffraction analyzer or an image analyzer.

The first solid electrolyte 21 may have a smaller median diameter than the coated active material 100 has. According to such a configuration, the coated active material 100 and the first solid electrolyte 21 can form a more favorable dispersion state in the positive electrode material 200.

The coated active material 100 may have a median diameter of 0.1 μm or more and 100 μm or less. In the case where the coated active material 100 has a median diameter of 0.1 μm or more, the coated active material 100 and the first solid electrolyte 21 can form a favorable dispersion state in the positive electrode material 200. Therefore, the charge and discharge characteristics of a battery are enhanced. Moreover, in the case where the coated active material 100 has a median diameter of 100 μm or less, the diffusion rate of lithium inside the positive electrode active material 11 is enhanced. Therefore, a battery can operate at a high output.

The coated active material 100 may have a larger median diameter than the first solid electrolyte 21 has. Even according to such a configuration, the coated active material 100 and the first solid electrolyte 21 can form a favorable dispersion state in the positive electrode material 200.

In the positive electrode material 200, the first solid electrolyte 21 and the coated active material 100 may be in contact with each other as shown in FIG. 4. In this case, the coating layer 12 and the first solid electrolyte 21 are also in contact with each other. The particles of the first solid electrolyte 21 may fill between the particles of the coated active material 100.

In the coated active material 100, the coating layer 12 may uniformly coat the positive electrode active material 11. In other words, the entire surface of the positive electrode active material 11 may be coated with the coating layer 12, so that the coated active material 100 is formed. The coating layer 12 suppresses direct contact between the positive electrode active material 11 and the first solid electrolyte 21, and thus suppresses generation of an oxide film due to oxidative decomposition of the first solid electrolyte 21. Therefore, according to such a configuration, the internal resistance of a battery is further reduced.

In the coated active material 100, the coating layer 12 may coat only a portion of the surface of the positive electrode active material 11. In other words, a portion of the surface of the positive electrode active material 11 may be coated with the coating layer 12, so that the coated active material 100 is formed.

The positive electrode material 200 may include a plurality of the first solid electrolytes 21 and a plurality of the coated active materials 100.

The content of the first solid electrolyte 21 in the positive electrode material 200 and the content of the coated active material 100 in the positive electrode material 200 may be equal to or different from each other.

### <Method for Producing Positive Electrode Material>

The coated active material 100 and the first solid electrolyte 21 are mixed together to obtain the positive electrode material 200. The method for mixing together the coated active material 100 and the first solid electrolyte 21 is not particularly limited.

For example, an implement such as a mortar may be used to mix together the coated active material 100 and the first solid electrolyte 21, or a mixer such as a ball mill may be used to mix together the coated active material 100 and the first solid electrolyte 21. The mixing ratio between the coated active material 100 and the first solid electrolyte 21 is not particularly limited.

### EMBODIMENT 3

Embodiment 3 will be described below. The description overlapping those of Embodiments 1 and 2 will be omitted as appropriate.

FIG. 5 is a cross-sectional view schematically showing the configuration of a battery 300 of Embodiment 3. The battery 300 of Embodiment 3 includes a positive electrode 31, an electrolyte layer 32, and a negative electrode 33. The electrolyte layer 32 is disposed between the positive electrode 31 and the negative electrode 33.

The positive electrode 31 includes the positive electrode material 200 of Embodiment 2. That is, the positive electrode 31 includes the coated active material 100 and the first solid electrolyte 21. The positive electrode 31 includes a material having properties of occluding and releasing metal ions (e.g., lithium ions).

According to the above configuration, the charge and discharge efficiency of the battery 300 can be enhanced.

In the ratio “v1:100-v1” between the volume of the positive electrode active material 11 and the sum of the volumes of the coating material and the first solid electrolyte 21 in the positive electrode 31, 30≤v1≤95 may be satisfied. Here, v1 represents the volume ratio of the positive electrode active material 11 based on 100 of the total volume of the positive electrode active material 11, the coating material, and the first solid electrolyte 21 included in the positive electrode 31. In the case where 30≤v1 is satisfied, a sufficient energy density of the battery 300 is easily ensured. In the case where v1≤95 is satisfied, the battery 300 more easily operates at a high output.

The positive electrode 31 may have a thickness of 10 μm or more and 500 μm or less. In the case where the positive electrode 31 has a thickness of 10 μm or more, the energy density of the battery 300 is sufficiently ensured. In the case where the positive electrode 31 has a thickness of 500 μm or less, the battery 300 can operate at a high output.

The electrolyte layer 32 is a layer including an electrolyte. The electrolyte is, for example, a solid electrolyte. The solid electrolyte included in the electrolyte layer 32 is referred to as a second solid electrolyte. That is, the electrolyte layer 32 may include a second solid electrolyte.

The second solid electrolyte can be at least one selected from the group consisting of a halide solid electrolyte, a sulfide solid electrolyte, an oxide solid electrolyte, a polymer solid electrolyte, and a complex hydride solid electrolyte.

The second solid electrolyte may include a solid electrolyte having the same composition as the composition of the solid electrolyte included in the first solid electrolyte 21 of Embodiment 2.

In the case where the second solid electrolyte includes a halide solid electrolyte, the second solid electrolyte may include a halide solid electrolyte having the same composition as the composition of the halide solid electrolyte included in the first solid electrolyte 21 of Embodiment 2. That is, the electrolyte layer 32 may include a halide solid electrolyte having the same composition as the composition of the halide solid electrolyte included in the first solid electrolyte 21 of Embodiment 2 described above. According to such a configuration, the characteristics of the battery can be further enhanced.

The second solid electrolyte may include a solid electrolyte having composition different from the composition of the solid electrolyte included in the first solid electrolyte 21 of Embodiment 2.

In the case where the second solid electrolyte includes a halide solid electrolyte, the second solid electrolyte may include a halide solid electrolyte having composition different from the composition of the halide solid electrolyte included in the first solid electrolyte 21 of Embodiment 2. That is, the electrolyte layer 32 may include a halide solid electrolyte having composition different from the composition of the halide solid electrolyte included in the first solid electrolyte 21 of Embodiment 2. According to such a configuration, the characteristics of the battery 300 can be further enhanced.

The second solid electrolyte may include a sulfide solid electrolyte. The second solid electrolyte may include a sulfide solid electrolyte having the same composition as the composition of the sulfide solid electrolyte included in the first solid electrolyte 21 of Embodiment 2. That is, the electrolyte layer 32 may include a sulfide solid electrolyte having the same composition as the composition of the sulfide solid electrolyte included in the first solid electrolyte 21 of Embodiment 2. According to the above configuration, since the electrolyte layer 32 includes the sulfide solid electrolyte having excellent reduction stability, a low-potential negative electrode material such as graphite or metallic lithium can be used for the negative electrode 33. Therefore, the energy density of the battery 300 can be enhanced. Moreover, in the case where the electrolyte layer 32 includes a sulfide solid electrolyte having the same composition as the composition of the sulfide solid electrolyte included in the first solid electrolyte 21 of Embodiment 2, the characteristics of the battery 300 can be further enhanced.

The second solid electrolyte may include an oxide solid electrolyte. The oxide solid electrolyte can be, for example, a NASICON solid electrolyte material typified by LiTi₂(PO₄)₃ and element-substituted substances thereof, a (LaLi)TiO₃-based perovskite solid electrolyte material, a LISICON solid electrolyte material typified by Li₁₄ZnGe₄O₁₆, Li₄SiO₄, and LiGeO₄ and element-substituted substances thereof, a garnet solid electrolyte material typified by Li₂La₃Zr₂O₁₂ and element-substituted substances thereof, Li₃PO₄ and N-substituted substances thereof, or glass or glass ceramics based on a Li—B—O compound, such as LiBO₂ or Li₃BO₃, to which Li₂SO₄, Li₂CO₃, or the like is added.

The second solid electrolyte may include a polymer solid electrolyte. The polymer solid electrolyte can be, for example, a compound of a polymer compound and a lithium salt. The polymer compound may have an ethylene oxide structure. The polymer compound having an ethylene oxide structure can contain a large amount of a lithium salt. Consequently, the ionic conductivity can be further enhanced. The lithium salt can be LiPF₆, LiBF₄, LiSbF₆, LiAsF₆, LiSO₃CF₃, LiN(SO₂F)₂, LiN(SO₂CF₃)₂, LiN(SO₂C₂F₅)₂, LiN(SO₂CF₃)(SO₂C₄F₉), LiC(SO₂CF₃)₃, or the like. The lithium salts may be used alone or in combination.

The second solid electrolyte may include a complex hydride solid electrolyte. The complex hydride solid electrolyte can be, for example, LiBH₄—LiI or LiBH₄—P₂S₅.

The electrolyte layer 32 may include the second solid electrolyte as its main component. That is, the electrolyte layer 32 may include the second solid electrolyte in a mass proportion of 50% or more (i.e., 50 mass % or more) in the entire electrolyte layer 32.

According to the above configuration, the characteristics of the battery 300 can be further enhanced.

The electrolyte layer 32 may include the second solid electrolyte in a mass proportion of 70% or more (i.e., 70 mass % or more) in the entire electrolyte layer 32.

According to the above configuration, the characteristics of the battery 300 can be even further enhanced.

The electrolyte layer 32 may include the second solid electrolyte as its main component and further include unavoidable impurities, or a starting material for use in synthesizing the second solid electrolyte, a by-product, a decomposition product, etc. The electrolyte layer 32 may include the second solid electrolyte in a mass proportion of 100% (i.e., 100 mass %) in the entire electrolyte layer 32, except for unavoidably incorporated impurities. That is, the electrolyte layer 32 may consist of the second solid electrolyte. According to the above configuration, the characteristics of the battery 300 can be further enhanced.

The electrolyte layer 32 may include, as the second solid electrolyte, two or more of the materials listed as the solid electrolyte. The two or more solid electrolytes are different in composition from each other. For example, the electrolyte layer 32 may include, as the second solid electrolyte, a halide solid electrolyte and a sulfide solid electrolyte.

The electrolyte layer 32 may have a thickness of 1 μm or more and 300 μm or less. In the case where the electrolyte layer 32 has a thickness of 1 μm or more, the positive electrode 31 and the negative electrode 33 are less prone to a short circuit. Moreover, in the case where the electrolyte layer 32 has a thickness of 300 μm or less, the battery 300 easily operates at a high output. That is, an appropriate adjustment of the thickness of the electrolyte layer 32 can ensure sufficient safety of the battery 300 and operate the battery 300 at a high output.

The negative electrode 33 includes a material having properties of occluding and releasing metal ions (e.g., lithium ions). The negative electrode 33 includes, for example, a negative electrode active material (e.g., negative electrode active material particles).

The negative electrode active material can be a metal material, a carbon material, an oxide, a nitride, a tin compound, a silicon compound, or the like. The metal material may be a simple substance of metal. The metal material may be an alloy. Examples of the metal material include lithium metal and a lithium alloy. Examples of the carbon material include natural graphite, coke, partially graphitized carbon, a carbon fiber, spherical carbon, artificial graphite, and amorphous carbon. Examples of the oxide include Li₄Ti₅O₁₂, LiTi₂O₄, and TiO₂. From the viewpoint of capacity density, silicon, tin, a silicon compound, or a tin compound can be suitably used.

The negative electrode 33 may include a solid electrolyte. A solid electrolyte that can be included in the negative electrode 33 is referred to as a third solid electrolyte. That is, the negative electrode 33 may include a third solid electrolyte. According to such a configuration, the lithium-ion conductivity inside the negative electrode 33 is enhanced, and consequently the battery 300 can operate at a high output. The third solid electrolyte that can be included in the negative electrode 33 can be any of the materials listed as examples of the second solid electrolyte of the electrolyte layer 32.

The negative electrode active material may have a larger median diameter than the third solid electrolyte included in the negative electrode 33 has. In this case, the negative electrode active material and the third solid electrolyte can form a favorable dispersion state.

In the ratio “v2:100-v2” between the volume of the negative electrode active material and the volume of the third solid electrolyte in the negative electrode 33, 30≤v2≤95 may be satisfied. Here, v2 represents the volume ratio of the negative electrode active material based on 100 of the total volume of the negative electrode active material and the third solid electrolyte included in the negative electrode 33. In the case where 30≤v2 is satisfied, a sufficient energy density of the battery 300 is easily ensured. In the case where v2≤95 is satisfied, the battery 300 more easily operates at a high output.

The negative electrode 33 may have a thickness of 10 μm or more and 500 μm or less. In the case where the negative electrode 33 has a thickness of 10 μm or more, a sufficient energy density of the battery 300 is easily ensured. In the case where the negative electrode 33 has a thickness of 500 μm or less, the battery 300 more easily operates at a high output.

At least one selected from the group consisting of the positive electrode 31, the electrolyte layer 32, and the negative electrode 33 may include a binder for the purpose of enhancing the adhesion between the particles. The binder is used to enhance the binding properties of the materials for the electrodes. Examples of the binder include polyvinylidene fluoride, polytetrafluoroethylene, polyethylene, polypropylene, an aramid resin, a polyamide, a polyimide, a polyamideimide, polyacrylonitrile, a polyacrylic acid, polyacrylic acid methyl ester, polyacrylic acid ethyl ester, polyacrylic acid hexyl ester, a polymethacrylic acid, polymethacrylic acid methyl ester, polymethacrylic acid ethyl ester, polymethacrylic acid hexyl ester, polyvinyl acetate, polyvinylpyrrolidone, a polyether, a polyethersulfone, hexafluoropolypropylene, styrene-butadiene rubber, and carboxymethyl cellulose. Moreover, the binder can be a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, an acrylic acid, and hexadiene. Furthermore, the binder may be a mixture of two or more selected from these materials.

At least one selected from the group consisting of the positive electrode 31 and the negative electrode 33 may include a conductive additive for the purpose of enhancing the electronic conductivity. The conductive additive can be, for example, graphite, such as natural graphite or artificial graphite, carbon black, such as acetylene black or Ketjenblack, a conductive fiber, such as a carbon fiber or a metal fiber, fluorinated carbon, a metal powder, such as an aluminum powder, a conductive whisker, such as a zinc oxide whisker or a potassium titanate whisker, a conductive metal oxide, such as titanium oxide, or a conductive polymer compound, such as a polyaniline compound, a polypyrrole compound, or a polythiophene compound. In the case where a conductive carbon additive is used, cost reduction of the battery 300 can be achieved.

The battery 300 can be configured as a battery having any of various shapes such as a coin type, a cylindrical type, a prismatic type, a sheet type, a button type, a flat type, and a stacked type.

The battery 300 can be produced by, for example, the following method.

The positive electrode material 200 of Embodiment 2, the material for forming the electrolyte layer 32, and the material for forming the negative electrode 33 are each prepared. A stack composed of the positive electrode 31, the electrolyte layer 32, and the negative electrode 33 that are disposed in this order is produced by a known method. Thus, the battery 300 is obtained.

An area of a main surface of the battery 300 is, for example, 1 cm² or more and 100 cm² or less. In this case, the battery 300 can be used for, for example, portable electronic devices, such as a smartphone and a digital camera. Alternatively, the area of the main surface of the battery 300 may be 100 cm² or more and 1000 cm² or less. In this case, the battery 300 can be used as, for example, a power source for a large mobile device, such as an electric vehicle. The “main surface” means a surface having the largest area in the battery 300.

### OTHER EMBODIMENTS

### Appendix

The following techniques are disclosed by the description of the above embodiments.

### (Technique 1)

A coated active material including:
a positive electrode active material;
lithium carbonate present on a surface of the positive electrode active material; and
a coating layer coating at least a portion of the surface of the positive electrode active material, wherein
the coating layer includes a lithium-containing fluoride, and
when a mass of the lithium carbonate is measured by neutralization titration, a proportion R1 of the mass of the lithium carbonate in a mass of the positive electrode active material is 0.43% or more and 1.4% or less.

According to this configuration, the internal resistance of a battery can be reduced.

### (Technique 2)

The coated active material according to Technique 1, wherein the proportion R1 is 1.0% or less. According to such a configuration, the internal resistance of a battery can be further reduced.

### (Technique 3)

The coated active material according to Technique 1 or 2, wherein the lithium-containing fluoride includes Li, Me1, Al, and F, and the Me1 is at least one selected from the group consisting of Ti and Zr. According to such a configuration, the ionic conductivity of the lithium-containing fluoride can be enhanced. Therefore, the internal resistance of a battery can be further reduced.

### (Technique 4)

The coated active material according to Technique 1 or 2, wherein the lithium-containing fluoride is represented by the following composition formula (1):

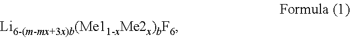

the Me1 is at least one selected from the group consisting of Ti and Zr, the Me2 is at least one selected from the group consisting of Al and Y, the m is a valence of the Me1, and 0<x<1 and 0<b≤3 are satisfied. According to such a configuration, the ionic conductivity of the lithium-containing fluoride can be enhanced. Therefore, the internal resistance of a battery can be further reduced.

### (Technique 5)

The coated active material according to Technique 4, wherein in the composition formula (1), 0.5≤xb<1 is satisfied. According to such a configuration, the ionic conductivity of the lithium-containing fluoride can be enhanced. Therefore, the internal resistance of a battery can be further reduced.

### (Technique 6)

The coated active material according to Technique 4 or 5, wherein in the composition formula (1), 2.5≤6−(m−mx+3x)b≤2.9, 0.1≤(1−x)b≤0.5, and 0.5≤xb≤0.9 are satisfied. According to such a configuration, the ionic conductivity of the lithium-containing fluoride can be enhanced. Therefore, the internal resistance of a battery can be further reduced.

### (Technique 7)

The coated active material according to any one of Techniques 4 to 6, wherein in the composition formula (1), the Me2 is Al. According to such a configuration, the internal resistance of a battery can be further reduced.

### (Technique 8)

The coated active material according to any one of Techniques 1 to 7, wherein the lithium-containing fluoride is at least one selected from the group consisting of Li_{2.7}Ti_{0.3}Al_{0.7}F₆ and Li_{2.8}Zr_{0.2}Al_{0.8}F₆. According to such a configuration, the internal resistance of a battery can be further reduced.

### (Technique 9)

The coated active material according to any one of Techniques 1 to 8, wherein the positive electrode active material includes a lithium nickel-containing oxide. According to such a configuration, the internal resistance of a battery can be reduced.

### (Technique 10)

The coated active material according to any one of Techniques 1 to 9, wherein the positive electrode active material includes lithium nickel cobalt aluminum oxide. According to such a configuration, the energy density of a battery can be increased.

### (Technique 11)

A method for producing a coated active material, including:
annealing a positive electrode active material in a carbon dioxide atmosphere at a temperature of 100° C. or higher and 700° C. or lower; and
coating at least a portion of a surface of the positive electrode active material with a coating material including a lithium-containing fluoride, wherein
the coating is performed by compositing the positive electrode active material and the coating material.

According to this configuration, a coated active material that can reduce the internal resistance of a battery can be produced.

### (Technique 12)

The method according to Technique 11, wherein a temperature of the annealing is 150° C. or higher and 400° C. or lower. According to such a configuration, a coated active material that can further reduce the internal resistance of a battery can be produced.

### (Technique 13)

The method according to Technique 11 or 12, including between the annealing and the coating, measuring a mass of lithium carbonate present on the surface of the positive electrode active material by neutralization titration. According to such a configuration, a coated active material that can reduce the internal resistance of a battery can be produced.

### (Technique 14)

The method according to Technique 13, including between the measuring and the coating, judging whether a proportion of the mass of the lithium carbonate in a mass of the positive electrode active material is 0.43% or more and 1.4% or less. According to such a configuration, a coated active material that can reduce the internal resistance of a battery can be produced.

### (Technique 15)

A positive electrode material including:
the coated active material according to any one of Techniques 1 to 10; and
a first solid electrolyte.

According to this configuration, the internal resistance of a battery can be reduced.

### (Technique 16)

The positive electrode material according to Technique 15, wherein the first solid electrolyte includes a halide solid electrolyte. According to such a configuration, the internal characteristics of a battery can be enhanced.

### (Technique 17)

The positive electrode material according to Technique 15 or 16, wherein the first solid electrolyte includes a sulfide solid electrolyte. According to such a configuration, the internal characteristics of a battery can be further enhanced.

### (Technique 18)

A battery including a positive electrode including the positive electrode material according to any one of Techniques 15 to 17.

According to this configuration, the internal resistance can be reduced.

### (Technique 19)

A battery including:
a positive electrode including the positive electrode material according to any one of Techniques 15 to 17;
a negative electrode; and
an electrolyte layer provided between the positive electrode and the negative electrode.

According to this configuration, the internal resistance can be reduced.

### (Technique 20)

The battery according to Technique 19, wherein the electrolyte layer includes a second solid electrolyte, and the second solid electrolyte includes a halide solid electrolyte having the same composition as composition of the solid electrolyte included in the first solid electrolyte. According to such a configuration, the output characteristics can be enhanced.

### (Technique 21)

The battery according to Technique 19 or 20, wherein the electrolyte layer includes a second solid electrolyte, and the second solid electrolyte includes a halide solid electrolyte having composition different from composition of the solid electrolyte included in the first solid electrolyte. According to such a configuration, the output characteristics can be enhanced.

### (Technique 22)

The battery according to any one of Techniques 19 to 21, wherein the electrolyte layer includes a second solid electrolyte, and the second solid electrolyte includes a sulfide solid electrolyte. According to such a configuration, the output characteristics can be further enhanced.

### EXAMPLES

The present disclosure will be described below in detail with reference to examples. The following examples are illustrative, and the present disclosure is not limited to the following examples.

### Example 1

### [Carbonate Annealing of Positive Electrode Active Material]

Li(Ni,Co,Al)O₂ (hereinafter referred to as NCA) having an average particle diameter of 5 μm was prepared as a positive electrode active material. Into a small tubular furnace, 500 g of NCA was placed. Annealing was performed on the NCA for 2 hours in a state in which the internal temperature of the small tubular furnace was set to 150° C. and carbon dioxide was flowed into the small tubular furnace at 10 mL/min. Thus, a positive electrode active material of Example 1 was obtained.

### [Production of Coating Material (Lithium-Containing Fluoride)]

In a glove box in an argon atmosphere controlled to a dew point of −60° C. or lower and an oxygen value of 5 ppm or less, LiF, AlF₃, and TiF₄ as raw material powders were weighed in a molar ratio of LiF:AlF₃:TiF₄=2.7:0.7:0.3. These raw material powders were mixed together in an agate mortar to obtain a mixture. Next, the mixture was subjected to a milling process with a planetary ball mill (Type P-7 manufactured by Fritsch GmbH) at 500 rpm for 12 hours. Thus, a synthesized product represented by the composition formula Li_{2.7}Ti_{0.3}Al_{0.7}F₆ (hereinafter referred to as LTAF) was obtained. The synthesized product and an appropriate amount of a solvent were mixed together and the synthesized product was subjected to a milling process with the planetary ball mill at 200 rpm for 20 minutes. The solvent was then removed by drying. Thus, a LTAF powder was obtained as a coating material (lithium-containing fluoride). The LTAF powder had an average particle diameter of 0.5 μm.

The average particle diameter of LTAF was calculated from a top-view SEM image of LTAF obtained with a scanning electron microscope (3D Real Surface View Microscope, VE-8800 manufactured by Keyence Corporation, magnification of 5000 times). Specifically, in a top-view SEM image of LTAF, 50 particles were randomly selected and the average value of their equivalent circle diameters was calculated as the average particle diameter.

### [Production of Coated Active Material]

Coating of the positive electrode active material of Example 1 with LTAF was performed with a particle composing machine (NOBILTA, NOB-MINI manufactured by Hosokawa Micron Corporation). Into the vessel of NOB-MINI, 48.5 g of the positive electrode active material and 1.5 g of LTAF were put. NCA and LTAF were composed under the conditions of a rotation speed of 6000 rpm, an operation time of 60 minutes, and a power value of 550 W to 740 W. Thus, a coated active material of Example 1 was obtained. The proportion of the volume of LTAF in the total of the volume of NCA and the volume of LTAF was 4.6%.

### Example 2

A coated active material of Example 2 was obtained in the same manner as in Example 1 except that in the carbonate annealing of the positive electrode active material, the internal temperature of the small tubular furnace was set to 400° C.

### Comparative Example 1

A coated active material of Comparative Example 1 was obtained in the same manner as in Example 1 except that in the carbonate annealing of the positive electrode active material, the internal temperature of the small tubular furnace was set to 800° C.

### Comparative Example 2

A coated active material of Comparative Example 2 was obtained in the same manner as in Example 1 except that NCA that had not been subjected to the carbonate annealing was coated with LTAF.

### (Measurement of Mass of Lithium-Containing Alkaline Component Present on Surface of Positive Electrode Active Material)

The following processes were performed for each of the positive electrode active materials before coating of the examples and the comparative examples. Into a beaker, 2 g of the positive electrode active material and 200 mL of ion-exchanged water were put, and stirred for 30 minutes followed by standing for 10 minutes. Next, the supernatant liquid was filtered through a syringe filter having a pore size of 0.2 μm, and the resultant filtrate was used as a test solution. A phenolphthalein solution serving as an indicator was added to the test solution, and neutralization titration was performed with use of a 0.1 mol/L aqueous HCl solution in a nitrogen atmosphere. After an end point was detected with phenolphthalein, a methyl orange solution serving as an indicator was added to the test solution, and neutralization titration was performed with use of a 0.1 mol/L aqueous HCl solution in a nitrogen atmosphere. On the assumption that lithium hydroxide (LiOH) and lithium carbonate (Li₂CO₃) were present on the surface of the positive electrode active material, from the amount of HCl required to reach the end point in each of the reactions, the mass of lithium hydroxide included in the test solution and the mass of lithium carbonate included in the test solution were calculated. The mass of lithium carbonate is the mass of lithium carbonate present on the surface of the positive electrode active material. Moreover, the mass of lithium derived from lithium carbonate was calculated from the mass of lithium carbonate. The mass of lithium derived from lithium hydroxide was calculated from the mass of lithium hydroxide. The total of the calculated mass of lithium derived from lithium hydroxide and mass of lithium derived from lithium carbonate is the mass of lithium derived from the lithium-containing alkaline component present on the surface of the positive electrode active material. From each calculated value and the mass of the positive electrode active material, a proportion R1 of the mass of lithium carbonate in the mass of the positive electrode active material, a proportion R2 of the mass of lithium derived from the lithium-containing alkaline component in the mass of the positive electrode active material, and a proportion R3 of the mass of lithium hydroxide in the mass of the positive electrode active material were calculated. The results are shown in Table 1.

### [Production of Evaluation Battery]

The following processes were performed with use of each of the coated active materials of the examples and the comparative examples.

### (Production of Paste for Positive Electrode Layer)

4.0 g of the coated active material, 0.094 g of VGCF as a conductive material, 1.024 g of a LiI—LiBr—Li₂S—P₂S₅-based glass ceramic (10LiI·15LiBr·75 (0.75Li₂S·0.25P₂O₅)) as the first solid electrolyte, 0.017 g of a butadiene rubber-based binder, and 2.77 g of tetralin were weighed and mixed together with an ultrasonic homogenizer (UH-50 manufactured by SMT Co., Ltd.). The resultant mixture was used as a paste for a positive electrode layer. “VGCF” is a registered trademark of SHOWA DENKO K.K.

### (Production of Paste for Negative Electrode Layer)

3.0 g of Li₄Ti₅O₁₂ particles (density: 3.5 g/cc) as a negative electrode active material, 0.033 g of conductive material carbon (density: 2 g/cc), 0.039 g of a butadiene rubber-based binder (density: 0.9 g/cc), and 3.71 g of tetralin were weighed and mixed together for 30 minutes with an ultrasonic homogenizer (UH-50 manufactured by SMT Co., Ltd.). Thereafter, 1.0 g of a LiI—LiBr—Li₂S—P₂S₅-based glass ceramic (10LiI·15LiBr·75 (0.75Li₂S·0.25P₂O₅), density: 2 g/cc) was added as a sulfide-based solid electrolyte to the slurry obtained by mixing, and the materials were mixed together again for 30 minutes with an ultrasonic homogenizer (UH-50 manufactured by SMT Co., Ltd.). The resultant mixture was used as a paste for a negative electrode layer.

### (Production of Paste for Electrolyte Layer)

Heptane, a heptane solution containing 5 mass % of a butadiene rubber-based binder, and 1.0 g of a LiI—LiBr—Li₂S—P₂S₅-based glass ceramic having an average particle diameter of 2.5 μm as a second solid electrolyte were loaded into a polypropylene vessel, and mixed together for 30 seconds with an ultrasonic homogenizer (UH-50 manufactured by SMT Co., Ltd.). Next, the vessel was shaken for 3 minutes with a shaker to obtain a paste for a solid electrolyte layer.

(Production of all-Solid-State Lithium Ion Secondary Battery)

The paste for a positive electrode layer was applied onto a positive electrode current collector (Al foil, thickness: 15 μm) by a blade method with an applicator. After the application, the paste was dried on a hot press at 100° C. for 30 minutes to obtain a positive electrode having a positive electrode active material layer on a surface of aluminum foil. In the same manner as in the positive electrode, the paste for a negative electrode layer was applied onto a negative electrode current collector (Ni foil, thickness: 22 μm) and dried to obtain a negative electrode having a negative electrode active material layer on a surface of Ni foil. In all of Examples 1 and 2 and Comparative Examples 1 and 2, the coating weight of the negative electrode active material layer was adjusted so that the charge specific capacity of the negative electrode was 1.15 times that of the positive electrode when the charge specific capacity of the positive electrode was 185 mAh/g.

The above positive electrode was pre-pressed. The paste for a solid electrolyte layer was applied onto a surface of the positive electrode active material layer of the positive electrode after the pre-pressing with a die coater, and dried on a hot plate at 100° C. for 30 minutes. Thereafter, roll pressing was performed at 2 ton/cm² to obtain a positive electrode side stack including a solid electrolyte layer on the surface of the positive electrode.

The above negative electrode was pre-pressed. The paste for a solid electrolyte layer was applied onto a surface of the negative electrode active material layer of the negative electrode after the pre-pressing with a die coater, and dried on a hot plate at 100° C. for 30 minutes. Thereafter, roll pressing was performed at 2 ton/cm² to obtain a negative electrode side stack including a solid electrolyte layer on the surface of the negative electrode.

The positive electrode side stack and the negative electrode side stack were each punched out and stacked so that the solid electrolyte layers were bonded to each other. Here, the stacking was performed in a state in which an unpressed solid electrolyte layer (paste for a solid electrolyte layer) was transferred between the solid electrolyte layer of the positive electrode side stack and the solid electrolyte layer of the negative electrode side stack. Thereafter, the stack was pressed at 160° C. at 2 ton/cm² to obtain a power generation element including a positive electrode, a solid electrolyte layer, and a negative electrode in this order. The resultant power generation element was sealed in a laminate and constrained at 0.5 MPa to obtain an all-solid-state lithium ion secondary battery (battery stack) for evaluation.

### (Evaluation)

Test batteries of the examples and the comparative examples were evaluated by the following procedure.

### (Initial Resistance)

The secondary battery was placed in a thermostatic chamber at 25° C. The following constant current, constant voltage (CCCV) charge and CCCV discharge were repeated twice. Constant-current charge was performed at a current value equivalent to 0.33 C relative to the theoretical capacity of the battery until a voltage of 2.7 V was reached, and then constant-voltage charge was performed at a voltage of 2.7 V. The charge was terminated at a current value equivalent to 0.01 C rate. Next, constant-current discharge was performed at a current value equivalent to 0.33 C until a voltage of 1.5 V was reached, and then constant-voltage discharge was performed at a voltage of 1.5 V. The discharge was terminated at a current value equivalent to 0.01 C rate. Next, the state of charge of the test battery was adjusted by the following CCCV charge. Constant-current charge was performed at a current value equivalent to 0.33 C relative to the theoretical capacity of the battery until a voltage of 2.0 V was reached, and then constant-voltage charge was performed at a voltage of 2.0 V. The charge was terminated at a current value equivalent to 0.01 C rate.

After the adjustment of the state of charge, the test battery was discharged for 2 seconds at a current of 12 mA/cm², and the internal resistance of the battery was determined by dividing an amount of voltage change by a discharge current. The results are shown in Table 1.

TABLE 1

| | Annealing | Mass | Mass | Mass | Internal |
|---|---|---|---|---|---|
| | temperature | proportion R1 | proportion R2 | proportion R3 | resistance |
| | [° C.] | [mass %] | [mass %] | [mass %] | [Ωcm²] |
| Example 1 | 150 | 0.48 | 0.31 | 0.73 | 6.6 |
| Example 2 | 400 | 1.0 | 0.35 | 0.56 | 5.9 |
| Comparative | 800 | 4.0 | 0.75 | 0.01 | 13.5 |
| Example 1 | | | | | |
| Comparative | Not | 0.42 | 0.30 | 0.77 | 6.8 |
| Example 2 | annealed | | | | |

### (Results)

Example 1 and Example 2 each exhibited a lower resistance than Comparative Example 2 without carbonate annealing of the positive electrode active material. Moreover, Example 1 and Example 2 each exhibited a lower resistance than Comparative Example 1 subjected to the carbonate annealing at 800° C. As described above, since the removal of water from the positive electrode active material starts from 150° C., it is presumed that the alkaline component on the surface of the positive electrode active material is controlled by the carbonate annealing at 150° C. Moreover, since water release converges around 400° C., it is presumed that when the carbonate annealing is performed in a state in which water near the surface layer has been removed, more effective surface control is achieved. According to these effects, the internal resistance of the battery was reduced. In a temperature range higher than 400° C., water release from the surface of the positive electrode active material does not occur, but it is presumed that the annealing in a high temperature range such as 800° C. causes a change in the crystal structure of NCA itself, resulting in an increase in resistance.

On the other hand, it is presumed that even within a temperature range where the annealing temperature is higher than 400° C., it is sufficiently possible to achieve a resistance smaller than 6.8 Ωcm² as long as the change in the crystal structure of the active material that causes an increase in the battery resistance does not occur. Regarding the positive electrode active material before being coated with the coating material, when the proportion R1 of the mass of lithium carbonate present on the surface of the positive electrode active material in the mass of the positive electrode active material is 0.43% or more and 1.4% or less, the alkaline component on the surface of the positive electrode active material is controlled, and thus the internal resistance of the battery is reduced.

### INDUSTRIAL APPLICABILITY

The battery of the present disclosure can be used as, for example, an all-solid-state lithium secondary battery.

What is claimed is:

1. A coated active material comprising:
a positive electrode active material;
lithium carbonate present on a surface of the positive electrode active material; and
a coating layer coating at least a portion of the surface of the positive electrode active material, wherein
the coating layer includes a lithium-containing fluoride, and
when a mass of the lithium carbonate is measured by neutralization titration, a proportion R1 of the mass of the lithium carbonate in a mass of the positive electrode active material is 0.43% or more and 1.4% or less.

2. The coated active material according to claim 1, wherein
the proportion R1 is 1.0% or less.

3. The coated active material according to claim 1, wherein
the lithium-containing fluoride includes Li, Me1, Al, and F, and
the Me1 is at least one selected from the group consisting of Ti and Zr.

4. The coated active material according to claim 1, wherein
the lithium-containing fluoride is represented by the following composition formula (1): 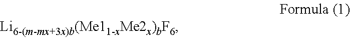
where
the Me1 is at least one selected from the group consisting of Ti and Zr,
the Me2 is at least one selected from the group consisting of Al and Y,
the m is a valence of the Me1, and
0<x<1 and 0<b≤3 are satisfied.

5. The coated active material according to claim 4, wherein
in the composition formula (1), 0.5≤xb<1 is satisfied.

6. The coated active material according to claim 4, wherein
in the composition formula (1), 2.5≤6−(m−mx+3x)b≤2.9, 0.1≤(1−x)b≤0.5, and 0.5≤xb≤0.9 are satisfied.

7. The coated active material according to claim 4, wherein
in the composition formula (1), the Me2 is Al.

8. The coated active material according to claim 1, wherein
the lithium-containing fluoride is at least one selected from the group consisting of Li_{2.7}Ti_{0.3}Al_{0.7}F₆ and Li_{2.8}Zr_{0.2}Al_{0.8}F₆.

9. The coated active material according to claim 1, wherein
the positive electrode active material includes a lithium nickel-containing oxide.

10. The coated active material according to claim 1, wherein
the positive electrode active material includes lithium nickel cobalt aluminum oxide.

11. A method for producing a coated active material, the method comprising:
annealing a positive electrode active material in a carbon dioxide atmosphere at a temperature of 100° C. or higher and 700° C. or lower; and
coating at least a portion of a surface of the positive electrode active material with a coating material including a lithium-containing fluoride, wherein
the coating is performed by compositing the positive electrode active material and the coating material.

12. The method according to claim 11, wherein a temperature of the annealing is 150° C. or higher and 400° C. or lower.

13. A positive electrode material comprising:
the coated active material according to claim 1; and
a first solid electrolyte.

14. The positive electrode material according to claim 13, wherein the first solid electrolyte includes a halide solid electrolyte.

15. The positive electrode material according to claim 13, wherein the first solid electrolyte includes a sulfide solid electrolyte.

16. A battery comprising a positive electrode including the positive electrode material according to claim 13.

17. A battery comprising:
a positive electrode including the positive electrode material according to claim 13;
a negative electrode; and
an electrolyte layer provided between the positive electrode and the negative electrode.

18. The battery according to claim 17, wherein
the electrolyte layer includes a second solid electrolyte, and
the second solid electrolyte includes a halide solid electrolyte having the same composition as composition of a solid electrolyte included in the first solid electrolyte.

19. The battery according to claim 17, wherein
the electrolyte layer includes a second solid electrolyte, and
the second solid electrolyte includes a halide solid electrolyte having composition different from composition of a solid electrolyte included in the first solid electrolyte.

20. The battery according to claim 17, wherein
the electrolyte layer includes a second solid electrolyte, and
the second solid electrolyte includes a sulfide solid electrolyte.
